(19) United States
(12) Patent Application Publication
(10) Pub. No.: US 2023/0008942 A1
(43) Pub. Date: Jan. 12, 2023

(54) METHOD, APPARATUS, AND SYSTEM FOR PROVIDING A DIGITAL ELEVATION MODEL FROM POSE POINTS

(71) Applicant: HERE Global B.V., Eindhoven (NL)

(72) Inventor: Jan Van SICKLE, Denver, CO (US)

(21) Appl. No.: 17/370,738

(22) Filed: Jul. 8, 2021

(51) Int. Cl. G06T 17/05; G06T 19/20

(52) U.S. Cl. CPC G06T 17/05; G06T 19/20; G06T 2219/2021; G06T 2200/24

(57) ABSTRACT

An approach is provided for digital elevation modeling from pose points. The approach, for example, involves retrieving a digital elevation model (DEM) representing a geographic area. The approach also involves retrieving pose point data associated with the geographic area. The pose point data, for instance, are collected using at least one sensor of at least one probe device traveling in the geographic area. The approach further involves editing the DEM based on the pose point data and providing the edited DEM as an output.

### BACKGROUND

Modern location-based services and applications (e.g., autonomous driving) are increasingly demanding highly accurate and detailed digital map data. This detailed map data generally includes a three-dimensional representation (e.g., a digital elevation model—DEM) of a topographic surface of the Earth. Historically, mapping service providers use remote aerial or satellite imagery to efficiently generate DEMs for large geographic areas. However, because of technical limitations associated with aerial or satellite imagery, the resulting DEMs often have errors that are often greater than what is needed for demanding applications such as but not limited to autonomous driving. Accordingly, map service providers face significant technical challenges with respect to generating DEMs at levels of accuracy needed for these applications.

### SOME EXAMPLE EMBODIMENTS

Therefore, there is a need for an approach for providing high accuracy digital elevation modeling (e.g., with an error of less than 1 meter).

According to one embodiment, a method comprises retrieving a digital elevation model (DEM) representing a geographic area. The method also comprises retrieving pose point data associated with the geographic area. The pose point data, for instance, are collected using at least one sensor of at least one probe device traveling in the geographic area. The method further comprises editing the DEM based on the pose point data. The method further comprises providing the edited DEM as an output.

According to another embodiment, an apparatus comprises at least one processor, and at least one memory including computer program code for one or more computer programs, the at least one memory and the computer program code configured to, with the at least one processor, cause, at least in part, the apparatus to retrieve a digital elevation model (DEM) representing a geographic area. The apparatus is also caused to retrieve pose point data associated with the geographic area. The pose point data, for instance, are collected using at least one sensor of at least one probe device traveling in the geographic area. The apparatus is further caused to edit the DEM based on the pose point data. The apparatus is further caused to provide the edited DEM as an output.

According to another embodiment, a non-transitory computer-readable storage medium carries one or more sequences of one or more instructions which, when executed by one or more processors, cause, at least in part, an apparatus to retrieve a digital elevation model (DEM) representing a geographic area. The apparatus is also caused to retrieve pose point data associated with the geographic area. The pose point data, for instance, are collected using at least one sensor of at least one probe device traveling in the geographic area. The apparatus is further caused to edit the DEM based on the pose point data. The apparatus is further caused to provide the edited DEM as an output.

According to another embodiment, an apparatus comprises means for retrieving a digital elevation model (DEM) representing a geographic area. The apparatus also comprises means for retrieving pose point data associated with the geographic area. The pose point data, for instance, are collected using at least one sensor of at least one probe device traveling in the geographic area. The apparatus further comprises means for editing the DEM based on the pose point data. The apparatus further comprises means for providing the edited DEM as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a digital elevation model (DEM) from pose points, according to one embodiment;

FIG. 2A is a diagram illustrating an example DEM determined from satellite imagery, according to one embodiment;

FIG. 2B is a diagram illustrating error resulting from generating a DEM from aerial or satellite imagery, according to one embodiment;

FIGS. 2C and 2D are diagrams illustrating examples of bare-earth related errors found in DEMs, according to one embodiment;

FIG. 3 is a diagram of components of mapping platform capable of providing a DEM from pose points, according to one embodiment;

FIG. 4 is a flowchart of a process for providing a DEM from pose points, according to one embodiment;

FIGS. 5A and 5B are diagrams illustrating example pose point data for editing a DEM, according to one embodiment;

FIG. 6 is a diagram of an example DEM edited based on pose point data, according to one embodiment;

FIG. 7 is a diagram of a geographic database, according to one embodiment;

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset) that can be used to implement an embodiment.

### DESCRIPTION OF SOME EMBODIMENTS

Examples of a method, apparatus, and computer program for providing a digital elevation model (DEM) from pose points are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

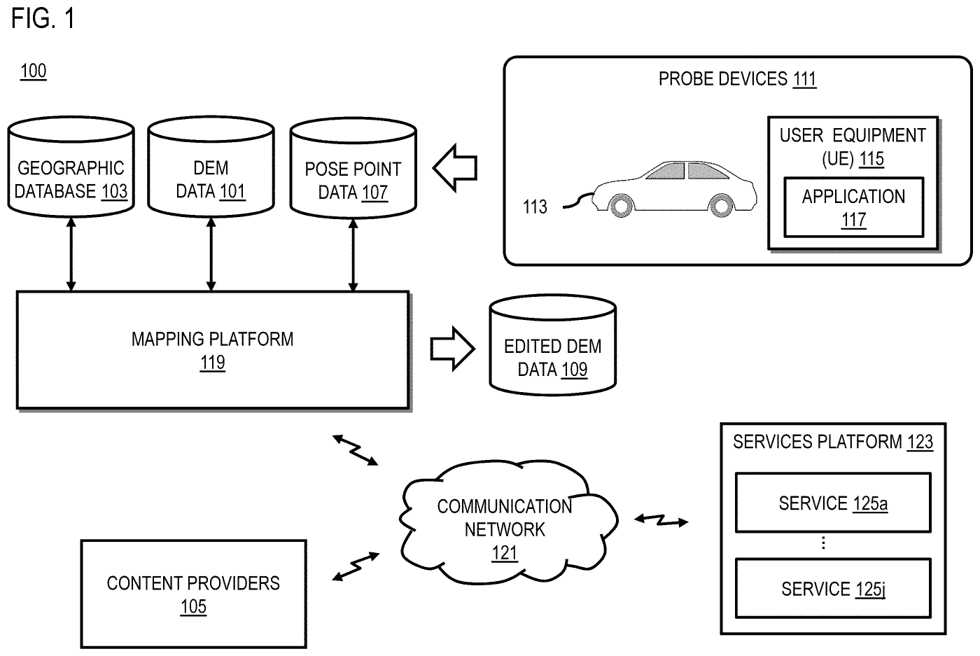

FIG. 1 is a diagram of a system capable of providing a digital elevation model (DEM) from pose points, according to one embodiment. As used herein, a DEM (e.g., as stored in or retrieved from DEM data 101) is a digital representation of the topographic surface of the Earth. Typically, a DEM represents the surface of the bare ground (also referred to as bare earth) in a corresponding geographic area. In one embodiment, a digital elevation model (DEM) can be a matrix of cells (e.g., grid cells such as but not limited to a square shape or any other shape capable of representing a surface). The matrix of cells can be organized in rows and columns that provide a three-dimensional (3D) graphic representation of terrain. Each cell represents a unit of area and contains a height (i.e., an elevation) of the corresponding area. Generally, DEMs are used for three-dimensional mapping of terrain to generate digital map data (e.g., digital map data of a geographic database 103).

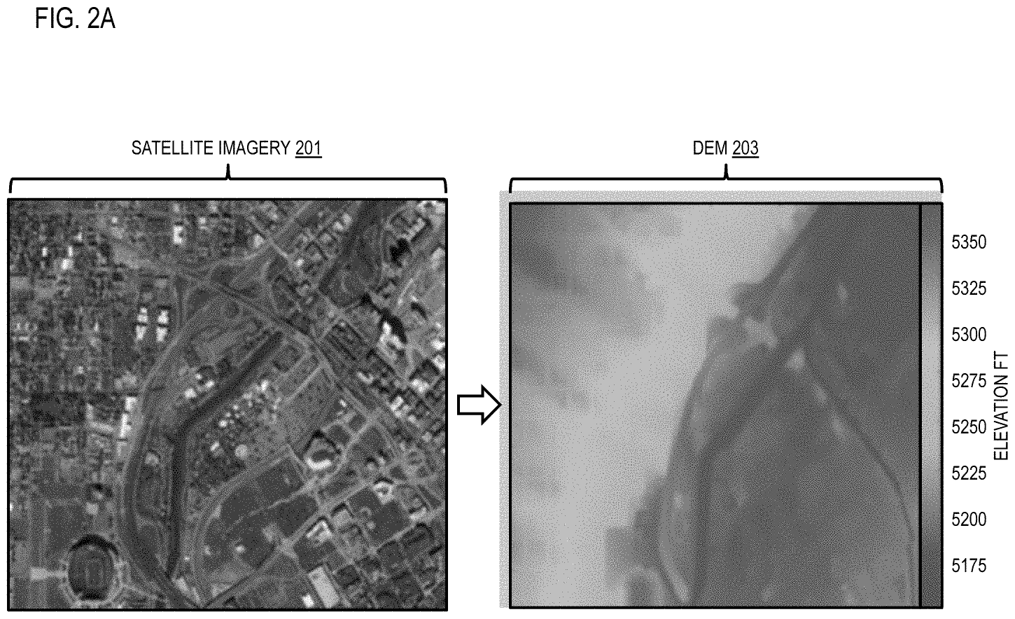

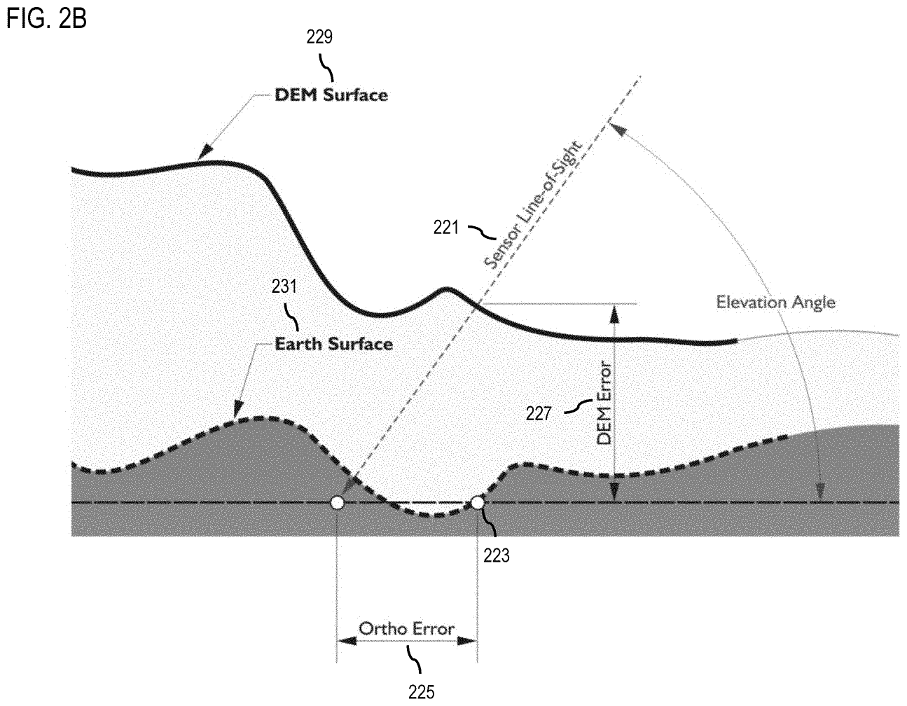

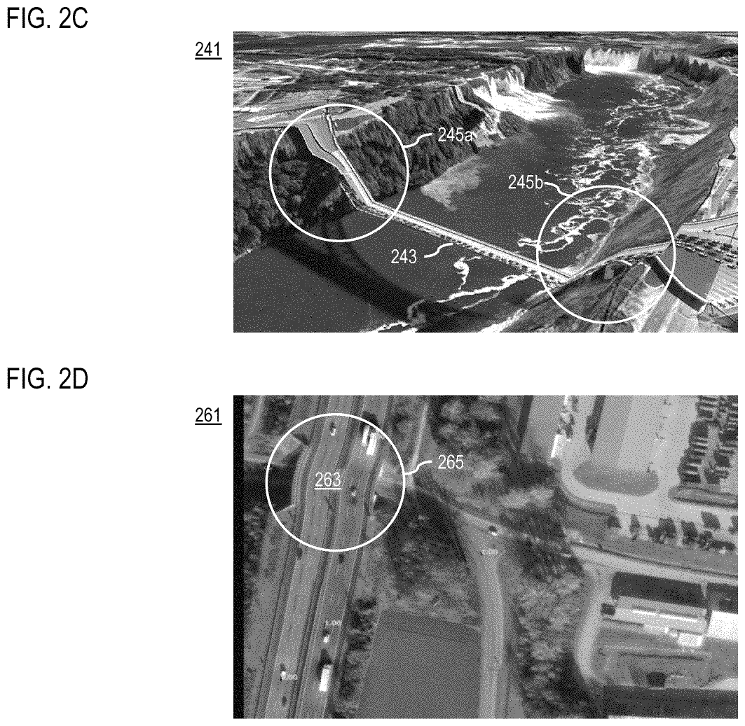

FIG. 2A is a diagram illustrating an example DEM determined from satellite imagery, according to one embodiment. In the example of FIG. 2A, satellite imagery 201 (or equivalent aerial imagery taken by an aerial vehicle such as but not limited to an airplane, drone, etc.) of a geographic area of interest is processed to generate a DEM 203 comprising multiple grid cells (e.g., represented as individual pixels of an image-like representation of the DEM 203). Each pixel or cell of the DEM 203 respectively represents a sub-area of the geographic area of interest. The color of each pixel represents the elevation or surface height of the corresponding sub-area as shown in FIG. 2A. In one embodiment, the pixels or cells of the DEM 203 form an orthomosaic representation of the terrain or topology of the geographic area of interest in which each pixel or cell of the orthomosaic is orthorectified to provide a direct top-down to the terrain and correct for camera angle and distortion. By way of example, the elevation data of the DEM 203 can be extracted from the satellite imagery 201 using, for instance, photogrammetry or any other equivalent process.

In one embodiment, certain applications of the digital map data (e.g., the geographic database 103) rely on a highly accurate derivation of surface characteristics (e.g., surface elevation data accurate to less than 1 meter) to generate high-definition live map (HDLM). Examples of these applications include but are not limited to autonomous driving, flood modeling etc., that rely on the accurate derivation of surface characteristics. This is especially true when remote sensing such as aerial or satellite imagery (photogrammetry) is involved in generating the DEM 203. The accuracy of the DEM 203 has a direct effect on both the horizontal and vertical accuracy of the resulting map or analysis.

Generally, geospatial accuracy of the orthomosaics in the DEM data 101 depends on the absolute and relative accuracy of the images (e.g., satellite imagery 201) prior to orthorectification and on the accuracy of the DEM as illustrated in FIG. 2B. As the sensor line of sight 221 deviates from nadir 223 both the horizontal and the vertical accuracy (e.g., ortho error 225) of the results deteriorates directly with the DEM error 227. This inaccuracy, for instance, is reflected in the vertical and/or horizontal misalignment of the DEM surface 229 (e.g., represented by a DEM orthomosaic) with the Earth surface 231 as shown in FIG. 2B.

As noted above, the DEM data 101 usually represents the bare surface of the Earth. Accordingly, when there are map features that are located above the surface of the Earth (e.g., overpasses, bridges, etc.), the relatively high error from remote sensing processes (e.g., aerial imagery, satellite imagery, etc.), can result in bare-earth related errors and obvious artifacts and rendering errors.

FIGS. 2C and 2D are diagrams illustrating examples of bare-earth related errors found in DEMs, according to one embodiment. In the example 241 of FIG. 2C, a DEM is used to render an image of a bridge 243 over a river. For example, the DEM may not include a representation of the bridge or may including the bridge with a vertical error that results in rendering the bridge 243 at a lower height than the actual bridge. This results in rendering errors 245a and 245b where the bridge appears distorted and stretched down to the incorrect height. Similarly, in the example 261, a highway overpass 263 is located above the bare surface. The corresponding DEM also has a vertical or elevation error that results in a rendering error 265 that distorts the overpass 263 into a curved rendering over the overpass 262. Thus, high error (e.g., greater than 1 meter) can result in poor quality mapping user interface outputs and/or other errors in end-use applications (e.g., incorrect autonomous driving commands, poor quality modeling of the environment, etc.).

Historically, there are a number of choices or sources (e.g., various content providers 105) for obtaining DEM data 101 in different geographies (e.g., some are in the public domain while others are available for purchase). Generally, all are inconsistent. For example, the current most widely used open-access global DEM is the Shuttle Radar Topography Mission (SRTM). However, both SRTM and another widely used DEM Advanced Spaceborne Thermal Emission and Reflection Radiometer (ASTER) exhibit large vertical errors which are exacerbated over complex topography. For instance, SRTM mission requirements defined absolute and relative elevation errors of 16 and 6 m, respectively. Commercial DEMs that may provide increased accuracy are often prohibitively costly. For example, Airbus Defense and Space's WorldDEM™ based on the TanDEM-X data, provides a global DEM of unprecedented quality, accuracy, and coverage with a vertical accuracy of 2 m (relative) and better than 6 m (absolute) at a 12 m spatial resolution. However, the errors stated, both in the absolute and relative are hardly sufficient for applications requiring an accuracy in the vertical of at least 1.0 m or better (e.g., 0.5 m) such as but not limited to autonomous driving. It is also noted that while this WorldDEM™ may be more accurate than the SRTM-DEM, it is (also) not a bare-earth DEM and so deriving an accurate terrain model from the TanDEM-X source data would require significant time and resources. Even higher accuracy published DEMs from aerial photogrammetry are significantly different from ground truth. These characteristics are not conducive to creating a high-quality (e.g., vertical error <1 m) “bare-earth DEM,” where objects (e.g., buildings and vegetation) have been removed from the elevation model. Such bare-earth DEMs are essential for applications such as high-definition live map (HDLM) for autonomous driving, flood modeling etc., that rely on the accurate derivation of surface characteristics.

As a result, service providers face significant technical challenges with respect to improving the accuracy of existing DEMs in an efficient and cost-effective manner.

To address these technical challenges, various embodiments of the system 100 described herein introduce a capability to achieve improvements in map accuracy (e.g., digital map data of the geographic database 103) by upgrading existing DEM data 101 (e.g., off-the-shelf DEMs through conflation with three-dimensional (3D) pose point data 107 to generate edited DEM data 109. In one embodiment, the pose point data 107 comprise one or more data points indicating a location and corresponding elevation determined from the sensors of probe devices 111 (e.g., vehicles 113 and/or user equipment (UE) devices 115 executing respective applications 117) traveling within a geographic area of interest. The location and elevation data of the pose point data 107 is then used to correct or edit the elevation data for the corresponding DEM or portion of the DEM in the DEM data 101 based on the assumption that the location and elevation data collected from probe devices 111 will be more accurate that the elevation data in the DEM. In one embodiment, the pose points of the pose point data 107 are ground control points (GCPs) which are points with known location/elevations that are accepted as ground truth data. These GCPs can be determined with using probe devices 111 with specialized high accuracy positioning sensors (e.g., greater accuracy than found in traditional consumer grade positioning devices such as consumer grade GPS receiver) or other equivalent ground surveying means.

In other words, in one embodiment, the probe devices 111 do not provide information for creating the DEM data 101 but, instead, provide data (e.g., pose point data 107) for correcting or editing the DEM data 101 (e.g., correcting the vertical and/or horizontal alignment of the DEM surface to the Earth's surface). Also, where the DEM excludes representation of roadways or other map features not on bare earth (or includes a less positionally accurate representation), the conflation of the DEM with pose point data 107 according to the various embodiments described herein can be used to correct the representations of roadways and/or other above surface features.

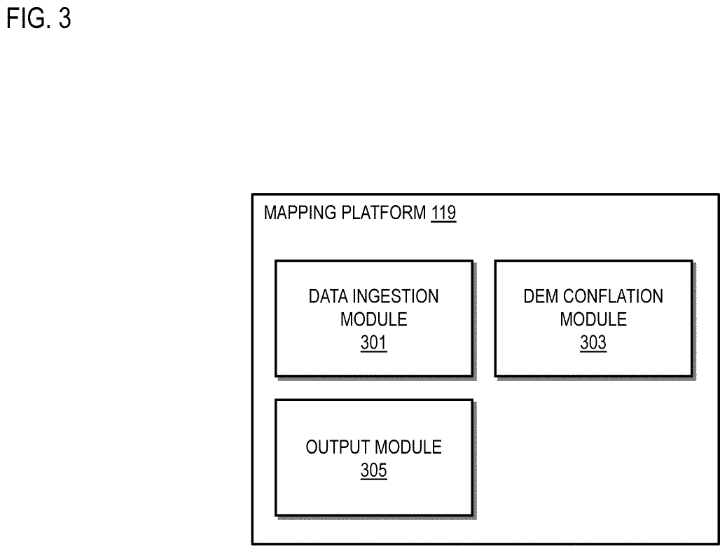

In one embodiment, the system 100 includes a mapping platform 119 for performing one or more functions associated with providing DEM data 101 from pose point data 107. FIG. 3 is a diagram of example components of the mapping platform 119, according to one embodiment. As shown, the mapping platform 119 includes a data ingestion module 301, a DEM conflation module 303, and an output module 305. The above presented modules and components of the mapping platform 119 can be implemented in hardware, firmware, software, or a combination thereof. Though depicted as a separate entity in FIG. 1, it is contemplated that the mapping platform 119 may be implemented as a module of any of the components of the system 100 (e.g., a component of the services platform 123, services 125, content providers 105, UEs 115, vehicles 113, and/or the like). It is also contemplated that the functions of the components of the mapping platform 119 may be combined or performed by other components of equivalent functionality. In another embodiment, one or more of the modules 301-305 may be implemented as a cloud-based service, local service, native application, or combination thereof. The functions of the mapping platform 119 and modules 301-305 are discussed with respect to the figures below.

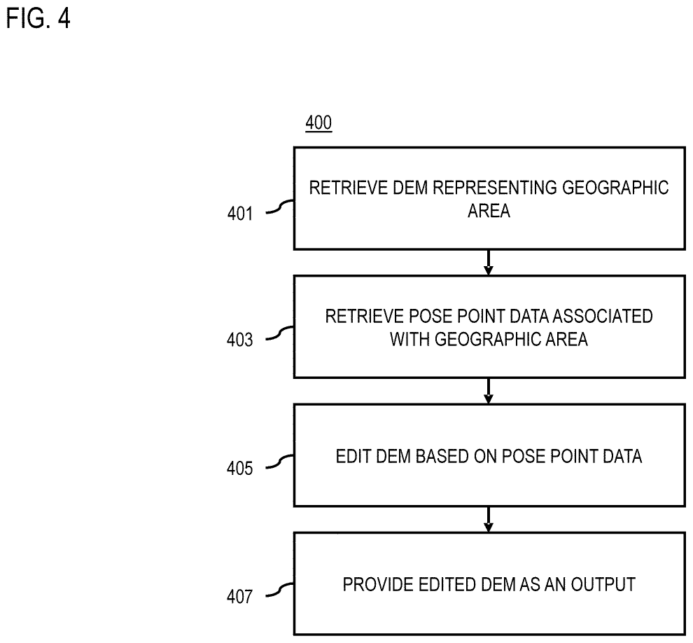

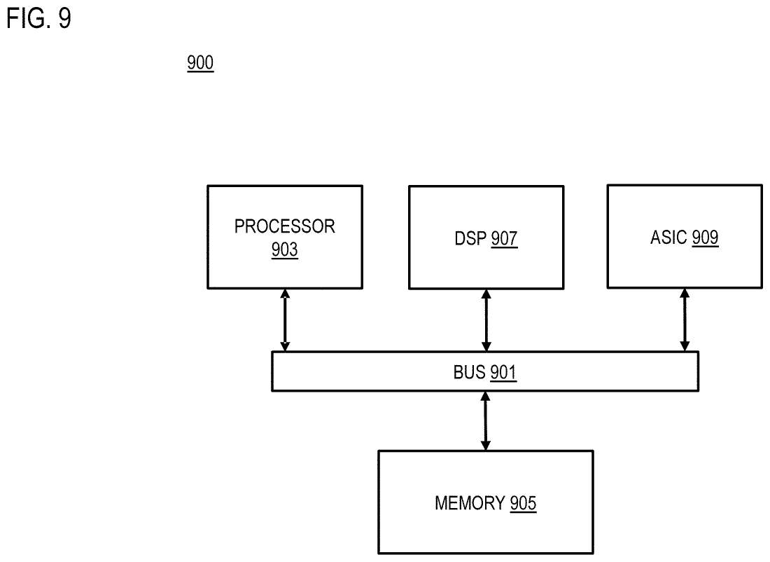

FIG. 4 is a flowchart of a process for providing a DEM from pose points, according to one embodiment. In various embodiments, the mapping platform 119 and/or any of the modules 301-305 may perform one or more portions of the process 400 and may be implemented in, for instance, a chip set including a processor and a memory as shown in FIG. 9. As such, the mapping platform 119 and/or any of the modules 301-305 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In one embodiment, the process 400 involves fusing pose point data 107 fused into a surrounding DEM (e.g., DEM data 101). Leveraging the pose point data 107 to edit the DEM data 101 will enable the system 100 to achieve very high accuracy not only in the direct vicinity of the road where the most stringent accuracy requirements need to be (e.g., for certain applications such as autonomous driving, navigation, etc.) but also between the roadways. This will create a substantial increase in the three-dimensional accuracy of all features and attributes such as localization objects (e.g., signs, poles, etc.), bridges, overpasses, underpasses, and/or equivalent map features of the geographic database 103. It will also allow much higher accuracy can be traditionally achieved from DEM data 101 derived only from remote sensing.

In step 401, the data ingestion module 301 retrieves a DEM representing a geographic area. By of example, the DEM can be retrieved from DEM data 101 provided by sources such as but not limited to open-source databases, commercial databases, and/or any other existing off-the-shelf DEM source. In addition or alternatively, the DEM sources can include databases that are proprietary to a respective services, etc. generated using any means (e.g., remote sensing as well as non-remote sensing like direct surveying, etc.). In some cases, the DEM is generated based on sensor data (e.g., imagery) collected using one or more aerial devices (e.g., airplanes, aerial drones, etc.), satellite devices, and/or any other remote sensing device capable of generating sensor data or imagery from an overhead perspective. In one embodiment, the one or more aerial devices (or other equivalent sensing devices) are different from the at least one probe device 111 is used to collect or generate the pose point data 107.

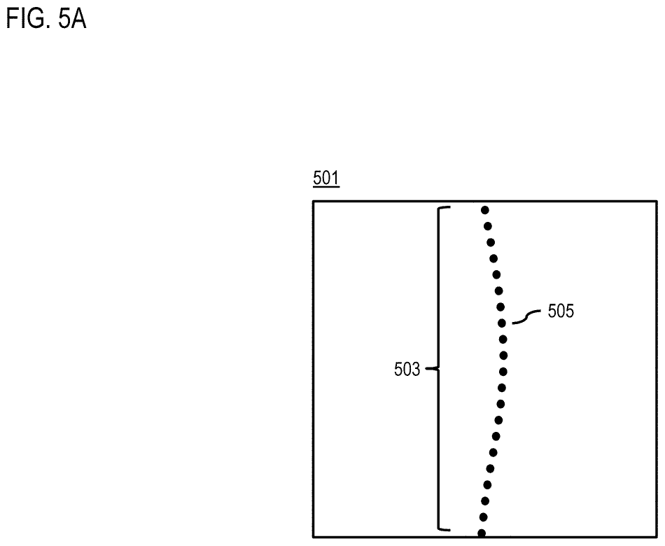

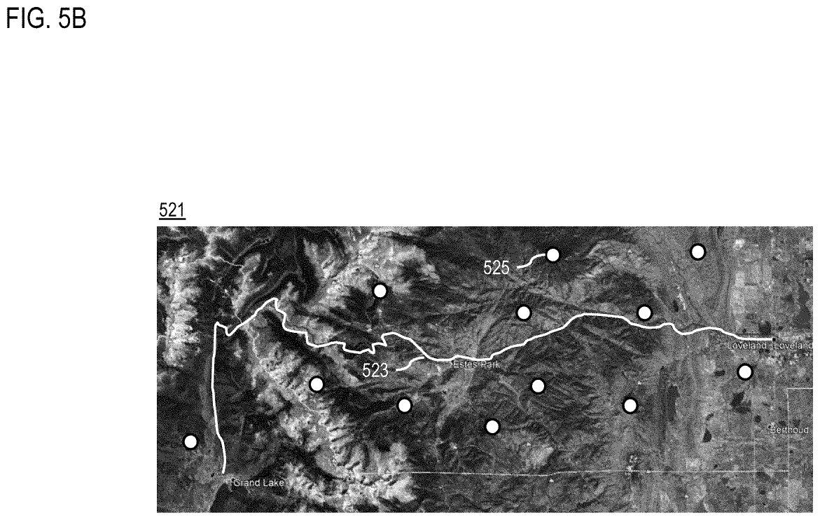

In step 403, the data ingestion module 301 retrieves pose point data 107 associated with the geographic area that, for instance, corresponds to the DEM of interest. In one embodiment, the pose point data 107 are collected using at least one sensor of at least one probe device 111 traveling in the geographic area of the DEM. For example, as shown in example 501 of FIG. 5A, the pose point data 107 comprises a sequence 503 of location data points 505. These location data points 505 are position sensor readings indicating, for instance, a location (e.g., latitude and longitude) and elevation of the probe device 111 at a point in time. It is also contemplated that additional parameters or characteristics of the probe device 111 such as but not limited to heading, speed, etc. of the probe device 111 at each location data point 505 can also be recorded in the pose point data 107.

In one embodiment, the probe device 111 can be configured to sense (e.g., via a positioning or location sensor—such as a GPS receiver or equivalent) and record its location at a specified frequency (e.g., once every 1 s, 2 s, 10 s, etc.). When the location data points 505 are arranged in chronological order according to position sampling time, a trajectory of the probe device 111 through the geographic area corresponding to the DEM can be constructed.

In one embodiment, the pose point data 107 can be differentially corrected to improve accuracy of the location and elevation of corresponding location data points 505. For example, the location data points can be determined using Differential GPS (DGPS) (or any other equivalent positioning technology) that can improve location data accuracy of the location data points 505 to a target level of accuracy (e.g., to meter-level accuracy or better). DGPS uses ground-based reference stations located at known locations that broadcast the difference between their known locations and their locations as determined from GPS or equivalent satellite signals. The difference (e.g., differences in the x, y, and z axes— 3D location difference) can then be used to correct the location readings taken by nearby GPS receivers.

For example, as shown in example 521 of FIG. 5B, a trajectory 523 of location data points (e.g., pose point data 107) is collected along a roadway through a geographic area of interest. Various ground-based reference stations (e.g., indicated by white circles and collectively referred to as reference stations 525) are located along the trajectory 423. The difference location values from the reference station 525 that is nearest each location data point of the trajectory 523 can then be used to correct the location and elevation values of the respective location data points. In this way, the pose point data 107 can be generated a target levels of accuracy for improving the accuracy of the corresponding DEM.

In addition or alternatively, the pose point data 107 can include a database of ground control points collected by probe devices 111 that are part of a fleet of specialized mapping vehicles. These mapping vehicles are equipped with positioning sensors (e.g., DGPS receivers) that provide positioning accuracy greater than traditional consumer or general-purpose vehicles. Mapping service providers (e.g., a service provider operating the mapping platform 119) often deploy fleets of vehicles to travel over and map road networks or a regular basis. As part of this effort, the vehicles can also generate ground control points (GCPs) along roadways. By way of example, GCPs are places on the ground with known locations that meet target levels of accuracy (e.g., greater than 1 meter accuracy). In one embodiment, the pose point data 107 for the geographic area associated with a DEM can be queried from this catalog or database of GCPs.

In other words, GCPs are defined as identifiable points on the Earth's surface that have precise location (e.g., in the form of <latitude, longitude, elevation/altitude/height>) associated with them. These points play a vital role in being able to measure the quality and correction of different data sources. GCPs find additional applications in camera pose refinement of satellite, aerial, and ground imagery, and hence provide for increased position fidelity for location data determined from these data sources. In turn, any derived products like building polygons, map objects made from these data sources inherit the accuracy. In addition, GCPs can also serve the localization of the automated car use case where they can be geocoded localization objects that a vehicle 113 can measure its position with respect to.

In one embodiment, GCPs are collected by ground surveyors who go out in the field and use instruments like a theodolite, measuring tape, three-dimensional (3D) scanner, satellite-based location sensors (e.g., GPS/GNSS), level and rod, etc. to measure the locations of ground control points with respect to the locations of distinguishable landmarks on the Earth (e.g. parts of signs, barriers, buildings, road paint, etc.).

In step 405, after retrieving the DEM (e.g., from the DEM data 101) and corresponding pose point data 107, the DEM conflation module 303 edits the DEM based on the pose point data 107. For example, the pose point data 107 is or can be three-dimensional pose point data (e.g., includes latitude, longitude, and altitude/elevation). Then, the DEM is edited based on the three-dimensional pose point data. In one embodiment, editing refers to adjusting or replacing the location and/or elevation data of the DEM with the location and/or elevation data of the pose point data 107. For example, as noted above, a DEM is generally represented as orthomosaic comprising cells of repeating geometric shapes (e.g., squares/pixels, triangles, etc.). These cells are also referred to as mosaic elements. Each cell or mosaic element represents a respective geographic area with a corresponding elevation. In this way, multiple cells of the DEM can be used to represent the terrain or topography of a given area. It is contemplated that the cells can represent any granular level of area (e.g., from square centimeters to square meters and beyond).

In one embodiment, the editing of the DEM then comprises editing one or more position parameters (e.g., latitude, longitude, altitude) of a mosaic element of the orthomosaic of the DEM based on the pose point data 107. To edit or correct the vertical error of the DEM, the DEM conflation module 303, for instance, can identify the one or more pose points that corresponding to an individual mosaic element or cell of the DEM. Then, the DEM conflation module 303 can adjust the elevation of the mosaic element to match the elevation of the corresponding pose points more closely. It is contemplated that any means to adjust the elevation to match can be used such as but not limited to: (1) replacing the elevation of the mosaic element with the elevation of the corresponding pose point; and (2) if there are more than one pose point matching the mosaic element (e.g., more than one pose point falls within the area covered by the mosaic element), then an average, mean, and/or other similar mathematical or statistical manipulation of the elevation values of the pose points can be used to replace the elevation of the mosaic element. It is noted that the above examples of editing the elevation values of a DEM mosaic element is provided by way of illustration and not as limitations.

In one embodiment, in addition to or in place of the vertical or elevation correction described above, the DEM conflation module 303 can adjust the horizontal alignment or error between the DEM surface and the corresponding pose point data 107. For example, the relative horizontal positions of the DEM surface and the corresponding pose point data can be adjusted until a best fit (e.g., based on least squares or equivalent metric) is achieved.

Thus, in one embodiment, the edited DEM will have the elevation (e.g., altitude) and/or location (e.g., latitude, longitude) of one or more of its constituent cells or mosaic elements adjusted to match or otherwise align with corresponding pose point data 107.

In one embodiment, the DEM conflation module 303 can determine one or more roadways associated with the pose point data 107 corresponding to a DEM. For example, pose point data 107 collected from vehicles generally will have trajectories that align with corresponding roadways (e.g., see the example trajectory 523 of FIG. 5B that takes the shape of the underlying roadway on which it is traveling). Thus, determining the roadway can be performed by taking trajectories that of vehicles that have traveled on road in the geographic area of interest. Then, only the portion or cells of the DEM that corresponding to roadways can be corrected without having to correct/edit the entire DEM. This is because in applications such as autonomous driving, it is assumed that the vehicles will normally be traveling only on the road and having high accuracy DEM on road ( ) can be sufficient.

In other embodiments, the DEM conflation module 303 can also identify portions of the DEM that are between two roads or within a threshold vicinity of a road for editing. For example, the DEM conflation module 303 can perform a spatial query of the geographic database 103 to identify such areas from the digital map data. Portions of the DEM corresponding to the results of the spatial query can be identified for editing. The portion of the DEM that is within a vicinity threshold (e.g., within 20 meters of the centerline of a road) or that is between one or more roadways can be edited based on the pose point data 107. In one embodiment, those portions can be edited based on the nearest pose point(s).

In one embodiment, the edited DEM is a bare-earth DEM. In other words, the edited DEM excludes features (e.g., vegetation, buildings, etc.) that are above the surface of the Earth. In this way, the DEM represents just the surface of the Earth. Then, features occurring above the surface (e.g., overpasses, underpasses, bridges, etc.) can be identified based on the pose point data 107 that occurs above the surface. For example, vehicles traveling over a bridge will have corresponding pose points that occur at a corresponding height above the surface of the Earth. Detecting portions of the DEM that includes pose point data at an elevation above the surrounding area by geometric arrangement indicative of an above surface feature (e.g., bridge) can then be used to include or otherwise associate the detected features in the DEM.

In one example use case, the various embodiments of the system 100 as described herein was able to achieve a three-times accuracy improvement in the area represented in the FIG. 5B. A portion DEM corresponding to the example 521 of FIG. 5B was used to produce an edited orthomosaic (edited DEM) based on corresponding pose point data 107. The circular error 90 percentile (CE90) over that portion improved from 2.66m to 0.79m. Thus, the various embodiments described herein generally can achieve high accuracy (e.g., greater than 1 m accuracy) from imagery based DEMs.

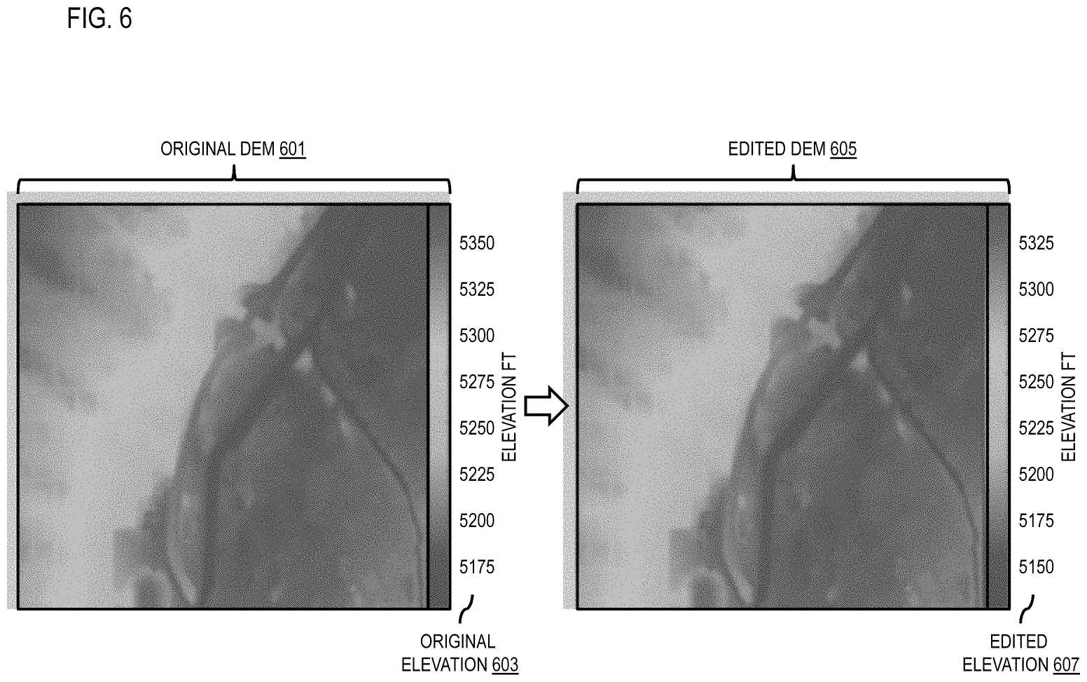

FIG. 6 is a diagram of an example DEM edited based on pose point data, according to one embodiment. As shown, an original and unedited DEM 601 is selected for processing and correction according to the embodiments described herein. Similar to the example of FIG. 2A, the original DEM 601 represents a geographic area using an image-like representation in which each pixel is a cell or mosaic element that corresponds to a portion of the entire geographic area. The color of each picture corresponds to a respective elevation as indicated by the original elevation legend 603 which spans the range from 5,175 feet to 5,350 feet. The system 100 processes original DEM 601 using corresponding pose point data 107 for the geographic area of interest. Based on the elevation data in the pose point data 107, the system 100 generates an edited DEM 605 that has been corrected down an average of 25 feet. This correction is indicated in this example by the edited elevation 607 being adjusted down by 25 feet across the range so that it now spans 5,150 feet to 5,325 feet to represent the terrain elevation more accurately in the corresponding geographic area.

In step 407, the output module provides the edited DEM as an output. By way of example, the output can be transmitted (e.g., over a communication network 121) to any service and/or application requesting high accuracy DEM data 101 (e.g., a services platform 123 comprising one or more services 125a-125j— also collectively referred to services 125). Examples of these services 125 include but are not limited to mapping services, navigation services, autonomous driving, environmental modeling, etc.

For example, in one embodiment, the output is used to generate a mapping user interface, a navigation user interface, or a combination thereof based on the output. Then, output module 305 presents the mapping user interface, the navigation user interface, or a combination thereof on an output device (e.g., a navigation device of a vehicle 113 or UE device 115 executing a location-based application 117). The resulting mapping and/or navigation user interface will then be able to represent the terrain or topography of a geographic at higher accuracy (e.g., greater than 1 m accuracy).

In another embodiment, the output is provided to an autonomous driving system of a vehicle 113. For example, autonomous driving is quickly becoming a reality following advances in machine learning, computer vision, and compute power. The ability to perceive the world with an accurate semantic understanding enables vehicles (e.g., an autonomous vehicle 113) to obey driving rules and avoid collisions. As these perceptual abilities have improved, so too has the need for highly accurate and up-to-date maps. Path planning, for instance, requires knowledge of what to expect beyond a vehicle 113's perceptual horizon, and driving in complicated terrains and environments with many occluding objects requires a knowledge of what may not be detectable by onboard sensors.

Returning to FIG. 1, as shown, the system 100 includes the mapping platform 119 for generating DEM data 101 based on pose point data 107 according to the various embodiments described herein. The mapping platform 119 also has connectivity or access to the geographic database 103 which stores digital map data for use in generating or otherwise using edited DEM data 109. In one embodiment, the geographic database 103 includes representations of mapped ground control points and related geographic features to facilitate DEM generation. As shown, the mapping platform 119 has connectivity over the communication network 121 to the services platform 123 that provides one or more services 125 that can use or provide data for generating DEM data 101 based on pose point data 107. By way of example, the services 125 may be third party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 119 to provide services 125 such as navigation, mapping, other location-based services, etc.

In one embodiment, the mapping platform 119 may be a platform with multiple interconnected components. The mapping platform 119 may include multiple servers, intelligent networking devices, computing devices, components, and corresponding software for providing DEM data 101 based on pose point data 107. In addition, it is noted that the mapping platform 119 may be a separate entity of the system 100, a part of the one or more services 125, a part of the services platform 123, or included within the UE 115 and/or vehicle 113. In one embodiment, content providers 105 (collectively referred to as content providers 105) may provide content or data (e.g., including DEM data 101, geographic data 103, pose point data 107, etc.) for use according to the various embodiments described herein.

In one embodiment, the UE 115 and/or vehicle 113 may execute a software application 117 to capture sensor data for generating DEM data 101 from pose point data 107 according to the embodiments described herein. By way of example, the application 117 may also be any type of application that is executable on the UE 115 and/or vehicle 113, such as autonomous driving applications, mapping applications, location-based service applications, navigation applications, content provisioning services, camera/imaging application, media player applications, social networking applications, calendar applications, and the like. In one embodiment, the application 117 may act as a client for the mapping platform 119 and perform one or more functions associated with generating DEM data 101 alone or in combination with the mapping platform 119.

By way of example, the UE 115 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 115 can support any type of interface to the user (such as “wearable” circuitry, etc.). In one embodiment, the UE 115 may be associated with the vehicle 113 or be a component part of the vehicle 113.

In one embodiment, the UE 115 and/or vehicle 113 are configured with various sensors for generating or collecting sensor data (e.g., for processing by the mapping platform 119), related geographic data, etc. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture ground control point imagery, etc. for analysis), an audio recorder for gathering audio data, velocity sensors mounted on steering wheels of the vehicles, switch sensors for determining whether one or more vehicle switches are engaged, and the like.

Other examples of sensors of the UE 115 and/or vehicle 113 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 115 and/or vehicle 113 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 115 and/or vehicle 113 may include GPS or other satellite-based receivers to obtain geographic coordinates for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 121 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 119, services platform 123, services 125, UE 115, vehicle 113, and/or content providers 105 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

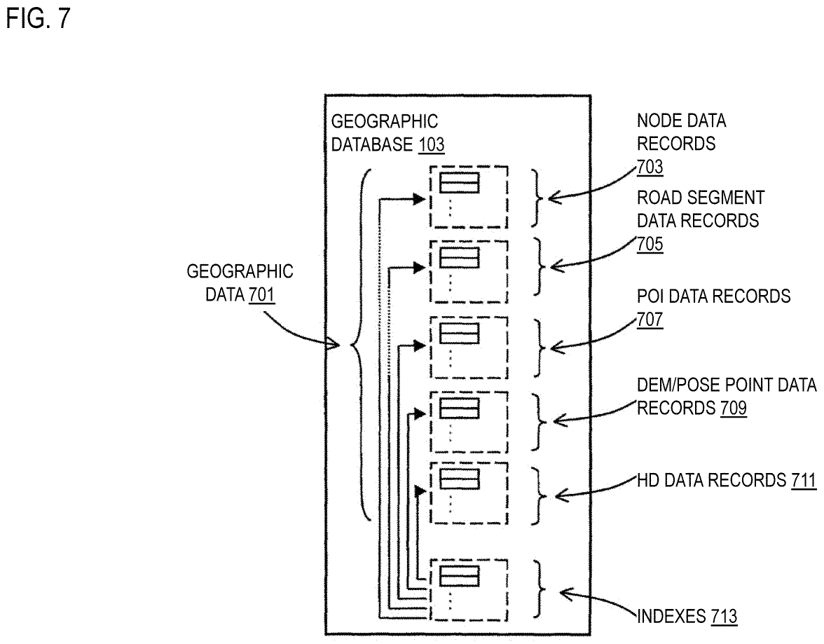

FIG. 7 is a diagram of a geographic database, according to one embodiment. In one embodiment, the geographic database 103 includes geographic data 701 used for (or configured to be compiled to be used for) mapping and/or navigation-related services, such as for video odometry based on the mapped features (e.g., lane lines, road markings, signs, etc.). In one embodiment, the geographic database 103 includes high resolution or high definition (HD) mapping data that provide centimeter-level or better accuracy of map features. For example, the geographic database 103 can be based on Light Detection and Ranging (LiDAR) or equivalent technology to collect billions of 3D points and model road surfaces and other map features down to the number lanes and their widths. In one embodiment, the HD mapping data (e.g., HD data records 711) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 103.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 103 follows certain conventions. For example, links do not cross themselves and do not cross each other except at a node. Also, there are no duplicated shape points, nodes, or links. Two links that connect each other have a common node. In the geographic database 103, overlapping geographic features are represented by overlapping polygons. When polygons overlap, the boundary of one polygon crosses the boundary of the other polygon. In the geographic database 103, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 103 includes node data records 703, road segment or link data records 705, POI data records 707, DEM/pose point data records 709, HD mapping data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 103. In one embodiment, the indexes 713 may be used to quickly locate data without having to search every row in the geographic database 103 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points corresponding to the respective links or segments of the road segment data records 705. The road link data records 705 and the node data records 703 represent a road network, such as used by vehicles, cars, and/or other entities. Alternatively, the geographic database 103 can contain path segment and node data records or other data that represent pedestrian paths or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 103 can include data about the POIs and their respective locations in the POI data records 707. The geographic database 103 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 103 can also include DEM/pose point data records 709 for storing data related to generating DEM data 101 from pose point data 107 according to the various embodiments described herein. By way of example, the DEM/pose point data records 709 can be associated with one or more of the node records 703, road segment records 705, and/or POI data records 707 to services and applications relying on edited DEM data 109 (e.g., autonomous driving, environmental modeling, etc.). In this way, the records 709 can also be associated with or used to classify the characteristics or metadata of the corresponding records 703, 705, and/or 707.

In one embodiment, as discussed above, the HD mapping data records 711 model road surfaces and other map features to centimeter-level or better accuracy. The HD mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 711 are divided into spatial partitions of varying sizes to provide HD mapping data to vehicles 113 and other end user devices with near real-time speed without overloading the available resources of the vehicles 113 and/or devices (e.g., computational, memory, bandwidth, etc. resources).

In one embodiment, the HD mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 711.

In one embodiment, the HD mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 103 can be maintained by the content provider 105 in association with the services platform 123 (e.g., a map developer). The map developer can collect geographic data to generate and enhance the geographic database 103. There can be different ways used by the map developer to collect data. These ways can include obtaining data from other sources, such as municipalities or respective geographic authorities. In addition, the map developer can employ field personnel to travel by vehicle (e.g., vehicle 113 and/or UE 115) along roads throughout the geographic region to observe features and/or record information about them, for example. Also, remote sensing, such as aerial or satellite photography, can be used.

The geographic database 103 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 113 or UE 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing DEM data 101 based on pose point data 107 may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

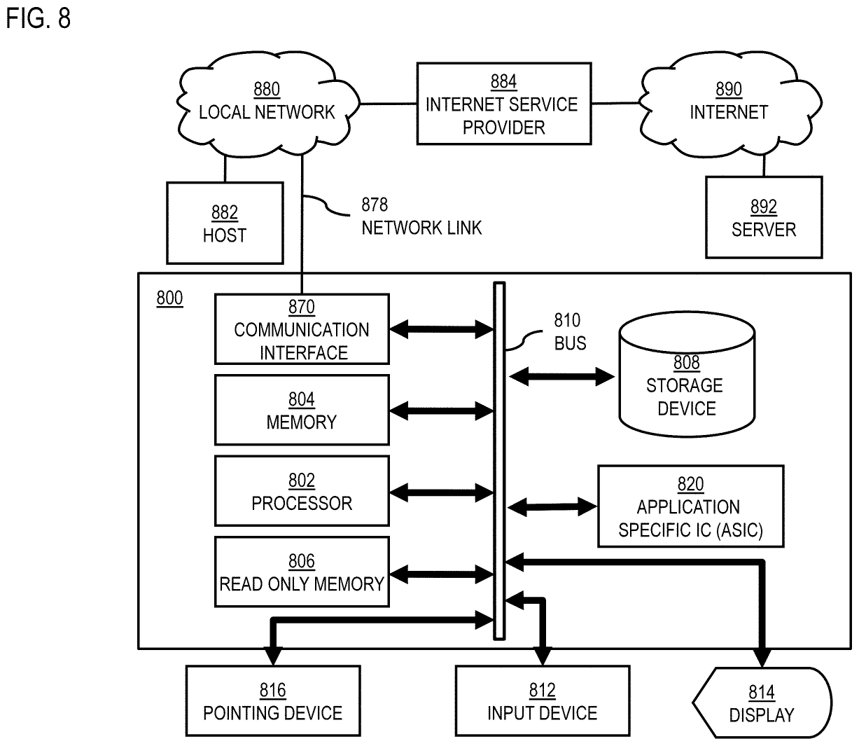

FIG. 8 illustrates a computer system 800 upon which an embodiment of the invention may be implemented. Computer system 800 is programmed (e.g., via computer program code or instructions) to provide DEM data 101 based on pose point data 107 as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing DEM data 101 based on pose point data 107. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing DEM data 101 based on pose point data 107. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing DEM data 101 based on pose point data 107, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives, or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 121 for providing DEM data 101 based on pose point data 107.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to provide DEM data 101 based on pose point data 107 as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide DEM data 101 based on pose point data 107. The memory 905 also stores the data associated with or generated by the execution of the inventive steps.

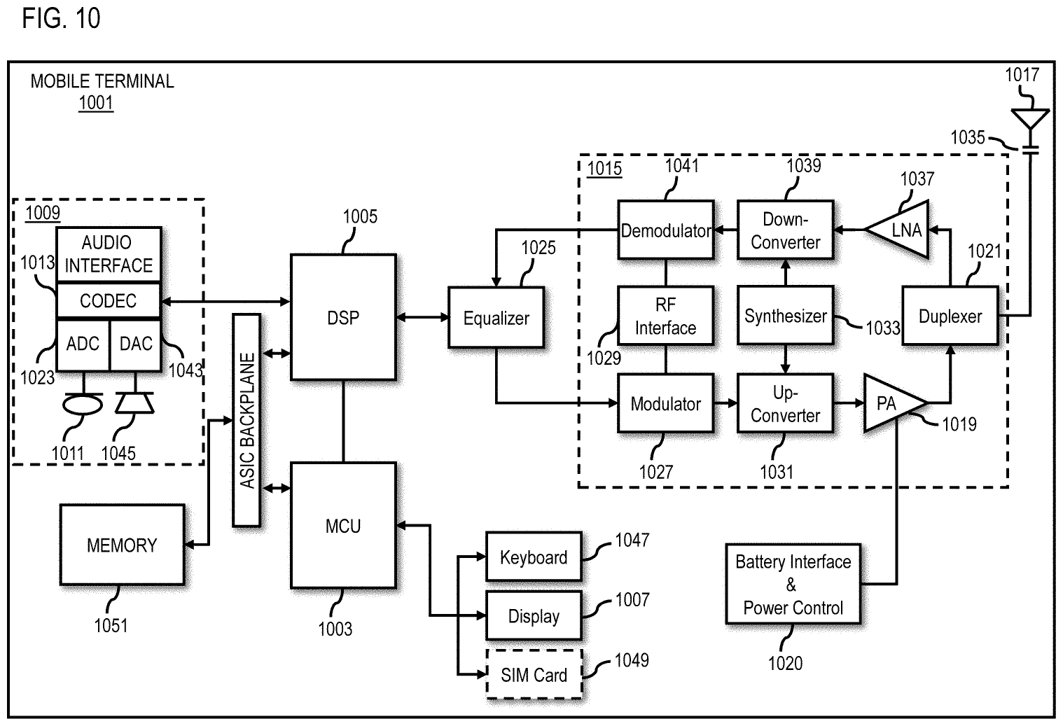

FIG. 10 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide DEM data 101 based on pose point data 107. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
retrieving, by one or more processors, a digital elevation model (DEM) representing a geographic area, wherein the DEM comprises elements of a repeating geometric shape;
retrieving, by the one or more processors, pose point data associated with the geographic area, wherein the pose point data are collected using at least one sensor of a plurality of probes traveling in the geographic area, wherein a probe is a ground vehicle or a user device carried by the ground vehicle;
editing, by the one or more processors, at least one element of the DEM based on at least one pose point among the pose point data falling within an area covered by the element; and
providing, by the one or more processors, the edited DEM as an output.

2. The method of claim 1, further comprising:
determining one or more bridges, one or more overpasses, one or more underpasses, or a combination thereof travelled by the ground vehicle when collecting the pose point data,
wherein a portion of the DEM that is within a vicinity threshold of the one or more bridges, the one or more overpasses, the one or more underpasses, or a combination thereof is edited based the pose point data, and
wherein the edited DEM is a bare-earth DEM.

3. The method of claim 10, wherein the pose point data includes pose point elevation data, and wherein the editing comprises replacing altitude of a mosaic element with altitude of one or more pose points falling within an area covered by the mosaic element.

4. The method of claim 1, wherein the pose point data is differentially corrected.

5. The method of claim 1, further comprising:
determining one or more roadways travelled by the ground vehicle when collecting the pose point data,
wherein a portion of the DEM that is within a vicinity threshold of the one or more roadways is edited based the pose point data.

6. The method of claim 1, further comprising:
determining one or more roadways travelled by the ground vehicle when collecting the pose point data,
wherein a portion of the DEM that is between the one or more roadways is edited based on the pose point data.

7. The method of claim 3, wherein the pose point data is three-dimensional pose point data, and wherein the DEM is edited based on the three-dimensional pose point data, and wherein the altitude of the mosaic element is an average or a mean of a plurality of pose points falling within the area covered by the mosaic element.

8. The method of claim 1, wherein the DEM is generated based on sensor data collected using one or more aerial devices.

9. The method of claim 1, wherein the one or more aerial devices is different from the plurality of probes.

10. The method of claim 1, wherein the DEM is an orthomosaic and the elements are mosaic elements, wherein the editing comprises replacing one or more position parameters of a mosaic element of the orthomosaic with one or more corresponding position parameters of at least one pose point falling within an area covered by the mosaic element, wherein the position parameters include latitude, longitude, altitude, or a combination thereof.

11. The method of claim 1, wherein the output is provided to an autonomous driving system of a vehicle.

12. The method of claim 1, further comprising:
generating a mapping user interface, a navigation user interface, or a combination thereof based on the output; and
presenting the mapping user interface, the navigation user interface, or a combination thereof on an output device.

13. An apparatus comprising:
at least one processor; and
at least one memory including computer program code for one or more programs,
the at least one memory and the computer program code configured to, with the at least one processor, cause the apparatus to perform at least the following,
retrieve a digital elevation model (DEM) representing a geographic area, wherein the DEM comprises elements of a repeating geometric shape;
retrieve pose point data associated with the geographic area, wherein the pose point data are collected using at least one sensor of a plurality of probes traveling in the geographic area, wherein a probe is a ground vehicle or a user device carried by the ground vehicle;
edit at least one element of the DEM based on at least one pose point among the pose point data falling within an area covered by the element; and
provide the edited DEM as an output.

14. The apparatus of claim 13, wherein the edited DEM is a bare-earth DEM.

15. The apparatus of claim 13, wherein the pose point data includes pose point elevation data, and wherein the editing comprises editing DEM elevation data based on the pose point elevation data.

16. The apparatus of claim 13, wherein the pose point data is differentially corrected.

17. A non-transitory computer-readable storage medium carrying one or more sequences of one or more instructions which, when executed by one or more processors, cause an apparatus to perform:
retrieving a digital elevation model (DEM) representing a geographic area, wherein the DEM comprises elements of a repeating geometric shape;
retrieving pose point data associated with the geographic area, wherein the pose point data are collected using at least one sensor of a plurality of probes traveling in the geographic area, wherein a probe is a ground vehicle or a user device carried by the ground vehicle;
editing at least one element of the DEM based on at least one pose point among the pose point data falling within an area covered by the element; and
providing the edited DEM as an output.

18. The non-transitory computer-readable storage medium of claim 16, wherein the edited DEM is a bare-earth DEM.

19. The non-transitory computer-readable storage medium of claim 16, wherein the pose point data includes pose point elevation data, and wherein the editing comprises editing DEM elevation data based on the pose point elevation data.

20. The non-transitory computer-readable storage medium of claim 16, wherein the pose point data is differentially corrected.
